(19) United States
(12) Patent Application Publication
(10) Pub. No.: US 2015/0208598 A1
(43) Pub. Date: Jul. 30, 2015

(54) Hydroponic Nutrient Delivery Gardening System

(71) Applicant: Lynn R. Kern, Tucson, AZ (US)

(72) Inventor: Lynn R. Kern, Tucson, AZ (US)

(21) Appl. No.: 14/540,053

(22) Filed: Nov. 13, 2014

Related U.S. Application Data
(60) Provisional application No. 61/932,889, filed on Jan. 29, 2014.

(51) Int. Cl. A01G 31/02; A01G 1/00

(52) U.S. Cl. CPC A01G 31/02; A01G 1/001

(57) ABSTRACT

An improved hydroponic nutrient delivery gardening system apparatus is described. This improved hydroponic delivery gardening system apparatus improves upon existing systems by minimizing the effects of sunlight and heat on the nutrient solution system without the use of an external nutrient cooling system, improve nutrient availability to roots, improve oxygen availability to roots, and improve the consistency of, and the ability to accurately measure, the pH of the media and nutrient mix.

### RELATED APPLICATION

This application claims the benefit of U.S. Provisional Patent Application Ser. No. 61/932,889 filed on Jan. 29, 2014.

### FIELD OF THE DISCLOSURE

The present disclosure relates generally to an improved nutrient delivery method and apparatus for hydroponic gardening. This improved nutrient delivery method and apparatus may also be usefully configured to work in various other arts beyond hydroponic gardening.

### BACKGROUND

Traditional terrestrial plants may be grown with their roots in the nutrient solution only, or in an inert medium. Hydroponic gardening is a method of growing plants without soil using only mineral nutrient solutions in water. Hydroponic gardening can be performed either indoors or outdoors. The obvious advantage of outdoor systems is the availability of natural sunlight—the optimal light source for growing. The disadvantages are the evaporative rates of the nutrient solution, accumulation of salt buildup from the fertilizers, and the natural heating of nutrient solution that occurs when exposed outdoors. The last of these disadvantages is the most damaging to the plant. As the solution temperature increases, the roots begin to be impacted and, if the temperature continues to rise, will cause the roots to “rot,” killing the plant. This fact precludes many areas from outdoor hydroponic farming and gardening.

There are several factors affecting the growth rate and produce (fruit, vegetable, etc.) yield in hydroponic gardening systems. Three of these factors are: nutrient availability to roots, oxygen availability to roots, and pH of the media and nutrient mix.

There have been many attempts to promote successful outdoor hydroponic gardening. One general technique is known as Deep Water Culture (DWC). In this system, the plant is suspended in a “netpot” made into the lid of a bucket containing nutrients and an airstone, delivering air to the roots. The simplest of these is a system consisting of a bucket (3-5 gallon), with a molded lid containing the grow medium and plant. An airstone is in the bucket to supply a continuous supply of air to the roots. This minimizes the possibility of the roots beginning the decay process, and provides a simplistic method to cool the water. One such example is manufactured by “The Root Spa Bucket System” company, part number RS5GALSYS.

Another variant of this type of system is currently manufactured by Current Culture H2O (CCH2O) that uses an active nutrient distribution system. The system allegedly re-circulates a “super-oxygenated” solution through the bottom of the bucket, providing superior performance.

There are several drawbacks to these systems and other implementations using Deep Water Culture technology.

Air Flow: The basic DWC systems has a near lethal drawback in this area. The system requires the airstone to be functioning properly on a continuous basis. Failure of the stone or air pump to function properly will rapidly reduce the oxygen supply in the water culture, causing root damage within just a day or two of failure. In the case of stone failures inside the grow buckets, failure often goes un-noticed until the plant begins to show stress, or the roots begin to deteriorate and die.

One system uses a single air pump for smaller systems and 2 air pumps for the larger systems. This minimizes the chances of an air flow failure, but does not address the need for course aeration. Nutrient solution is circulated through the pump and back though the grow buckets in a linear manner, meaning the buckets closest to the central reservoir get the water with the highest concentration of dissolved oxygen in the water.

Water flow and Temperature: The basic DWC bucket also has minimal cooling capability. The only cooling is accomplished through the aeration of the nutrient solution by the air system. This means the basic DWC system is not appropriate for outdoor use, as the bucket must maintain complete light blackout to prevent light pollution into the root system. These buckets are—without exception—black, which further exacerbates the self-heating issues in warmer climates. The only water flow and mixing is due to the flow caused by the airstone.

The Under Current system has the options for both a reservoir and an external water chiller. Ideal water temperature for hydroponic systems is between 55° F. and 70° F. and the manufacturer suggests a chiller if the ambient temperature is too high to maintain water temperature. This system also attempts to deal with the issue of salt and waste build-up around the roots over the course of the feeding cycle. The water is pulled through the buckets and a mesh filter before being returned to the reservoir. Each bucket contains an airstone to help keep the nutrient solution around the roots fresh. One issue with this system is the fact the nutrients come in from the bottom. The nutrient solution is heavier than water, which tends to keep the nutrient rich solution at the bottom of the bucket. The only stirring mechanism is the airstone previously discussed. This once again presents a single point of failure should the airstone become clogged and non-functional. The basic system is available from the CCH2O website.

One issue with this system is the water flow is forced using negative pressure, so if one of the bucket “out ports” becomes plugged with roots, all flow on subsequent buckets stop. Additionally, as the roots age and “sluff off” some of the non-productive root material, a mesh screen filter serves as a single point of failure where the entire system can stop functioning properly on the failure of a single part.

The height of the water in either of these systems is controlled by design. This means if the gardener needs more or less water exposure to the roots, the only option is to elevate the lid above the bucket, which defeats the “light-tight” design of most DWC systems. This can be a problem if the same system is used in different configurations, based on the plants being grown, and the gardener's experience.

pH Testing and Water Change-out: None of the systems discussed have an easy way to extract water for the daily pH testing required as the nutrient concentration changes throughout the feeding cycle. The basic DWC bucket requires the lid to be displaced, roots exposed to light pollution, and a water sample collected. The bucket has a blue tube used to drain the bucket, but is not an acceptable method to gather the test sample daily. The water in the tune is not exposed to the air or fresh nutrient solution and may not reflect the actual pH in the grow chamber.

The CCH2O system has a reservoir that from which the sample can be taken but it is not certain that the pH in the reservoir is the same as in the grow buckets. Using a negative flow system implies the water is moving fast enough through the buckets to keep the nutrient solution mixed, and the waste products extracted from the system at a rate sufficient to see a uniform pH throughout the system. But this will be the case only when each bucket sub-system is functioning correctly, and mixing the waste with the fresh nutrient solution as the pump pulls the solution through the buckets.

Additional problems can result in weekly to bi-weekly water change-outs, which is the rule of thumb in hydroponic gardening. The basic DWC bucket requires either a wholesale swap of the old buckets for fresh buckets each week, or having the buckets elevated enough to use the blue tube to drain the bucket. The refill port can also be the drain port just used. The problem that is any plant material that has made its way into the bucket, either from leaf or root, is not necessarily removed. As this material can build up over weeks, the effects can be very deleterious to plant growth if the material begins to decay and poisons the plant.

The Under Current system contains drain connections in the reservoir, but there is nothing in the individual bucket to remove the water from the bottom. Since the system uses negative pressure, when the water level reaches a point that exposes the circulation tubes, the pump will begin to “suck air” instead of the intended water, and the rest of the water in the system drains through gravity only. This is not conducive to removing anything from the bottom of the buckets, as there is no flow rate to carry the effluent away, nor can it get past the mesh screen at the end of the system.

This system also forces the nutrient enriched water to pass from one plant to the next before being returned to the reservoir for additional oxygenation, and a re-mix of the nutrient-salt mixture. In essence, each succeeding plant in the system is exposed to a higher ratio of waste to nutrient than the first plant in the system. In positive flow systems, the nutrients are provided through a single line with taps for each plant site. This method also causes the first plant to see more flow than the plant on the terminal end, providing a non-uniform nutrient distribution throughout the system.

The issues described above are some of the reasons the need for cleanliness in hydroponic systems. Without sufficient flow to transport waste materials, the buckets accumulate those waste materials throughout the grow cycle, limiting optimal growth in the plant. Any additional influx of plant material can cause catastrophic failure of the system.

Accordingly, there is a need for an improved method and apparatus to minimize the effects of sunlight and heat on the nutrient solution system without the use of an external nutrient cooling system. There is also a need for an improved method and apparatus which will improve nutrient availability to roots, improve oxygen availability to roots, and improve the consistency of, and the ability to accurately measure, the pH of the media and nutrient mix.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a system diagram of an improved hydroponic grow bucket and top bucket assembly, in accordance with some embodiments.

FIG. 2 is a system diagram of an improved water manifold, in accordance with some embodiments.

FIG. 3 is a system diagram of an improved hydroponic nutrient delivery system, in accordance with some embodiments.

FIG. 4 is a system diagram of water-flow in an improved hydroponic grow bucket and top bucket assembly, in accordance with some embodiments.

FIG. 5 is a system diagram of air-flow in an improved hydroponic grow bucket and top bucket assembly, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

This solution uses many of the same principles discussed above but overcomes the limitations of each of these existing systems. The basic system provides continuous water flow and aeration, but delivers each of these requirements in a novel manner to the plant. Using a manifold for water flow, the serial delivery method is unnecessary. The manifold equalizes pressure for all bucket feed lines, providing uniform water flow and nutrient delivery, independent of the number of stations between the source and furthest bucket from the pump. Nutrients are dissolved in the water solution, just as with any other DWC system. A central reservoir holds approximately the same amount of water as the grow buckets. The system relies on positive pressure and gravity to induce flow rates through the system. A water distribution manifold provides equal flow to all grow sites in the system. Light integrity of the grow buckets is maintained not by using light-proof materials, but uses an inner liners and outer buckets to prevent light pollution. This allows for the use of light reflective materials, to minimize the effects of solar heating on the reservoirs and grow buckets. This also allows for rapid removal of diseased or sick plants without affecting or shutting down the rest of the system for more than a few minutes. Nutrient solution is exposed to both the fine aeration (same as that used in existing systems), and adds course aeration by allowing the water to “fall” in two locations, the individual buckets, and the main reservoir.

The improved hydroponic nutrient delivery gardening system method and apparatus described herein creates a more optimal growing environment for plants by minimizing the effects of sunlight and heat on the nutrient solution system without the use of an external nutrient cooling system, improves nutrient availability to roots, improves oxygen availability to roots, and improves the consistency of, and the ability to accurately measure, the pH of the media and nutrient mix.

The water manifold described herein equalizes pressure for all bucket feed lines, providing uniform water flow and nutrient delivery, independent of the number of stations between the source and furthest grow bucket from the pump. This method may render the serial delivery methods of other systems unnecessary.

In the described system, nutrients are dissolved in the water solution, which is similar to other Deep Water Cultivation (DWC) systems. A central reservoir holds approximately the same amount of water as the grow buckets. The system relies on positive pressure and gravity to induce flow rates through the system. A water distribution manifold provides equal flow to all grow sites in the system. Light integrity of the grow buckets is maintained through the use of inner liners and outer buckets to prevent light pollution. This allows for the use of light reflective materials, to minimize the effects of solar heating on the reservoirs and grow buckets. In addition, this also allows for rapid removal of diseased or sick plants without affecting or shutting down the rest of the system for more than a couple minutes. Nutrient solutions are exposed to both fine aeration (through the use of airstones) and course aeration by allowing the water to “fall” in two locations, the individual buckets and the main reservoir.

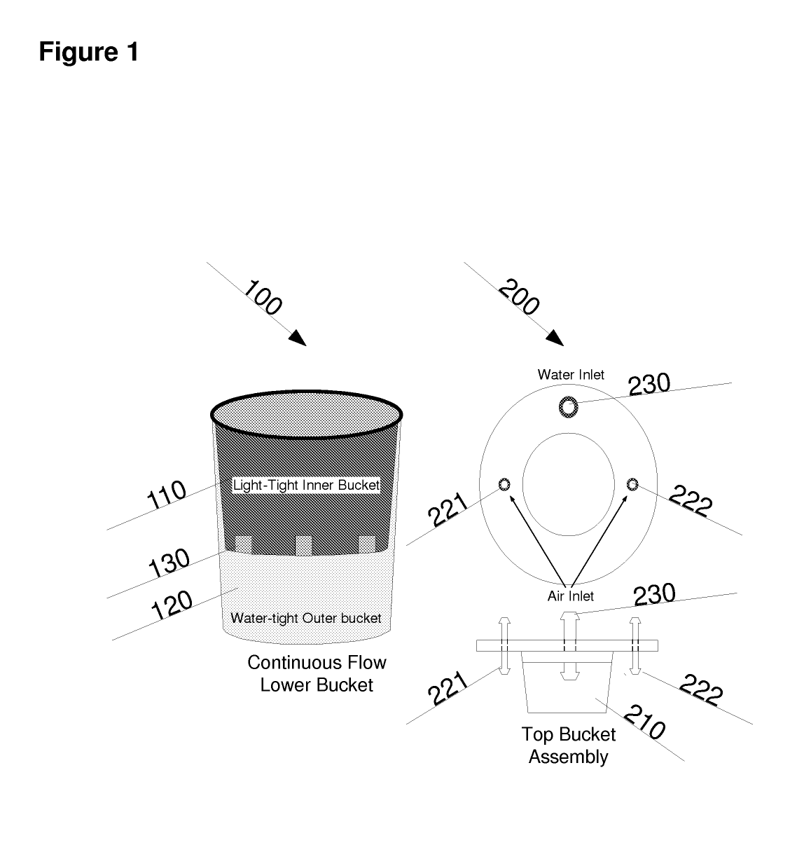

Turning to FIG. 1, shown is a continuous flow lower grow bucket 100 and top bucket assembly 200 apparatus embodiment of an improved hydroponic nutrient delivery gardening system. Included are a light-tight or light resistant inner bucket 110, water-tight or water resistant outer bucket 120, holes to allow water and air transfer from the inner bucket to the outer bucket 130, netpot 210, air inlet connectors 221 222, and water inlet connector 230. (A portion of the top bucket assembly 200 is shown in an overhead view and a side view.)

The top bucket assembly 200 acts as the bucket lid for the continuous flow lower bucket 100. It may consist of an industry standard 5 gallon DWC lid and be outfitted with a netpot 210 for holding the plant, and connectors/inlets for air 221 222 and water 230. These connectors may be a barb style or any number of quick-disconnect styles. These connectors may allow for the rapid removal of a lid 200 and inner liner bucket 110 if a plant becomes diseased or infested. Airstones attached to the air connectors 221 222, which may provide fine aeration when attached to one or more air pumps, may also be replaced rapidly should they become clogged or otherwise non-functional.

The outer bucket 120 may be a standard 5 gallon water tight bucket with a 2″ shower drain attached to the center of the bottom of the bucket. The drain may be that of a standard floor or shower drain, or any other suitable drain-style, but can be the same size as the manifold in the delivery sub-system. In order to utilize parts from existing hydroponic systems, the outer bucket may be of a standard size. The bottom drain design may also allow the buckets to be completely drained for maintenance and/or feeding without removing or opening any of the grow buckets.

The inner liner bucket 110 may be one of any off-the-shelf nursery-style pots, as long as they are do not allow light penetration, so as to act as a light barrier to protect to the plant roots. The inner lining may have several, equally spaced holes in the bottom 130 to allow for the flow from the inner liner bucket 110 to the outer bucket 120.

The combination of inner liner bucket 110 and outer bucket 120 may form an enhanced grow area where the water and air flow rate are concentrated around the roots of the plant. Since the water is in a constant “froth” around the roots, the nutrient/oxygen/water mix around the roots may always be the freshest possible, and the salts and waste generated from the plant has an opportunity to settle in the bottom of the outer bucket 120, until it may be washed out during water change-outs. Should salts and sediment be picked up by the drain system, the reservoir trap may trap them, preventing recirculation of the materials.

The system may be designed to provide nutrient water flow at a rate of approximately 2 gallons per minute per bucket, and air flow at a rate of 5 liters per minute per bucket.

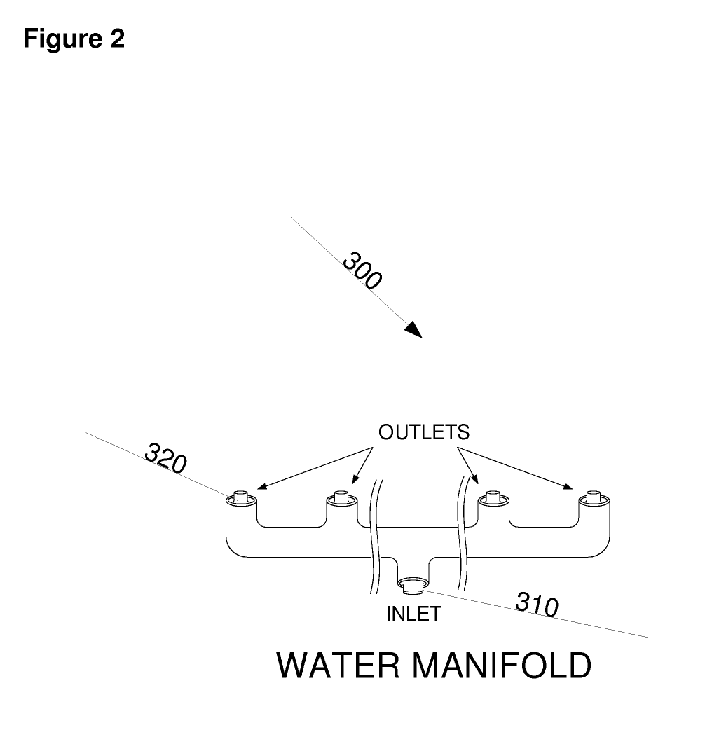

Turning to FIG. 2, shown is a water manifold 300 apparatus embodiment of an improved hydroponic nutrient delivery gardening system. Included are water inlet 310 and any number of water outlets 320. Previous hydroponic gardening systems relied on water flow through the use of a linear and/or serial delivery system, where the pressure at the closest port to the water pump has the highest flow, while the furthest port has the lowest flow. This causes an uneven water flow between the buckets and the level of oxygenation dependent on the position of the bucket from the pump. This improved design may alleviate the water delivery issues. The water manifold does not rely on a linear or serial delivery system, and instead equalizes pressure between all the delivery lines.

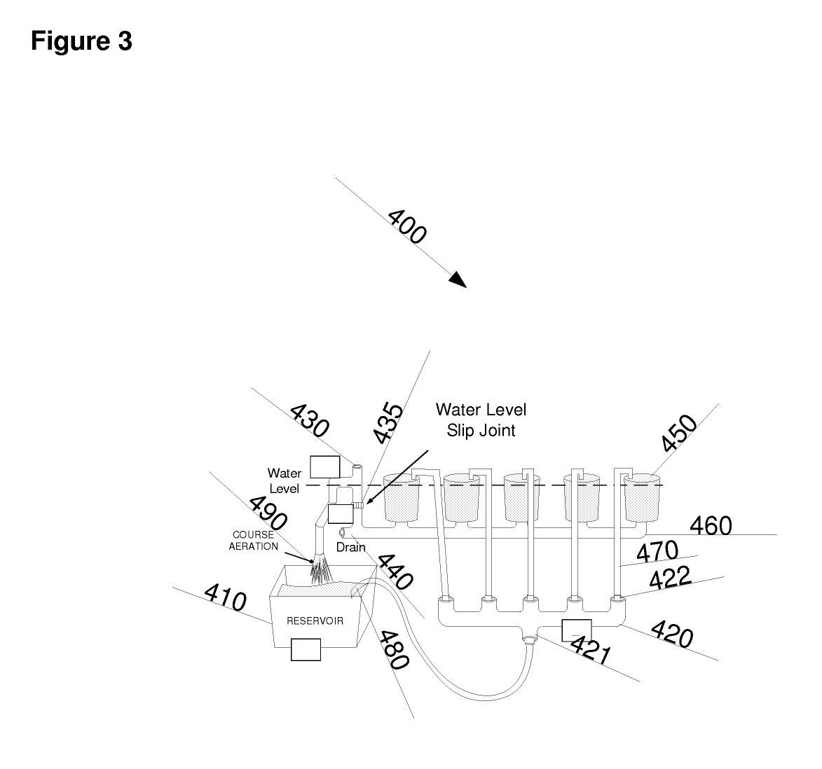

Turning to FIG. 3, shown is a hydroponic nutrient delivery system 400 embodiment of an improved hydroponic nutrient delivery gardening system. Included are a reservoir 410, water manifold 420, water manifold inlet 421, one or more water manifold outlets 422, trap 430, adjustable sleeve 435, drainage connection 440, one or more grow buckets 450, drain system 460, one or more feed lines 470, pump outlet 480, and vertical drop 490.

Water may be picked up a pump in the reservoir 410 and delivered to the water manifold 420. To maintain equal pressure out of the water manifold outlets 422, the water manifold 420 diameter may be 4-6 times the size of the individual feed line 470 to the grow buckets. To maximize flow into the water manifold 420, the water manifold inlet 421 may be the same size as the pump outlet 480. The feed lines 470 to each grow bucket may be attached to the bucket lid through a standard right-angle or straight connector. Drains in the bottom of each bucket may connect to adjoining buckets via a drain system 460. The terminal bucket may have a trap 430 constructed, which may set the overall height of the water in all the attached buckets. The water height may be adjusted by use of an adjustable sleeve 435. This adjustable sleeve 435 may also allow for a large vertical drop of the water 490 back into the reservoir 410. This drop 490 may further aid course aeration, which may also cool the water—allowing for outdoor gardening with the use of a water chiller. The drain system 460 may be a standard “shower-drain” style system, which may be comprised of standard 2″ PVC plumbing. The drain pipe diameter of the system should equal the water manifold diameter in order to maintain proper flow throughout the system.

As designed, the system may also provide for easy water removal and cleanout of the buckets. On the end of the drain system 460 that contains the trap 430, there may also be a connection 440 for drainage. This connection 440, which may be controlled by a valve, is at the lowest point in the water system. When this connection or valve 440 is opened, the reservoir 410 pumps water through the buckets, but stops when the water level is below the trap 430. At this point, the remaining water may drain out, the reservoir 410 may be drained, and fresh water may be placed in the reservoir 410. Since there are multiple holes in the inner liner buckets, clean water may be used to “flush” the entire system if the need arises. Furthermore, due to the large diameter drain system 460, plant material that might die off, is expelled and can reach the reservoir 410 without impediment. Due to the external reservoir 410 design, it may be possible to use clean water to flush the system at any point, and be reasonably assured that the salts and waste products have been removed from the inner liner bucket and outer bucket.

Since the water manifold 420 might force water to travel through parallel paths to the grow buckets 450, there might be a greater probability that the pH in the reservoir 410 matches that of the grow buckets 450. This design allows the gardener/farmer/user to gather a single sample of water from the reservoir 410 for testing, and be assured that adjustments made are optimal for all plants in the system.

Existing systems experience a predictable shift in pH throughout the feeding period. Typically, the pH will rise immediately after feeding and then drop to below ideal levels over the feeding period (which may be weekly). Pushing the air and water flow via recommended rates, the system exhibits a very different behavior. The nutrient mixture is balanced prior to adding it to the reservoir, to minimize the pH shock to the plants when nutrients are introduced. Also, the nutrients are normally visible for a few days in the water before it begins to clear, depending on the nutrients used. With this system, the water may be visibly clearer the morning following feeding, and the pH balances within 3 days to 5.8-6.0. This pH is maintained for the rest of the feeding cycle (which may be a week), if nothing else is added. Because the nutrients appear to be absorbed so quickly by the plant, it may be possible to feed at 100% on day 1, and then feed again at 50% on day 4. Ideally, water may be changed out weekly, and the reservoir may be washed out monthly.

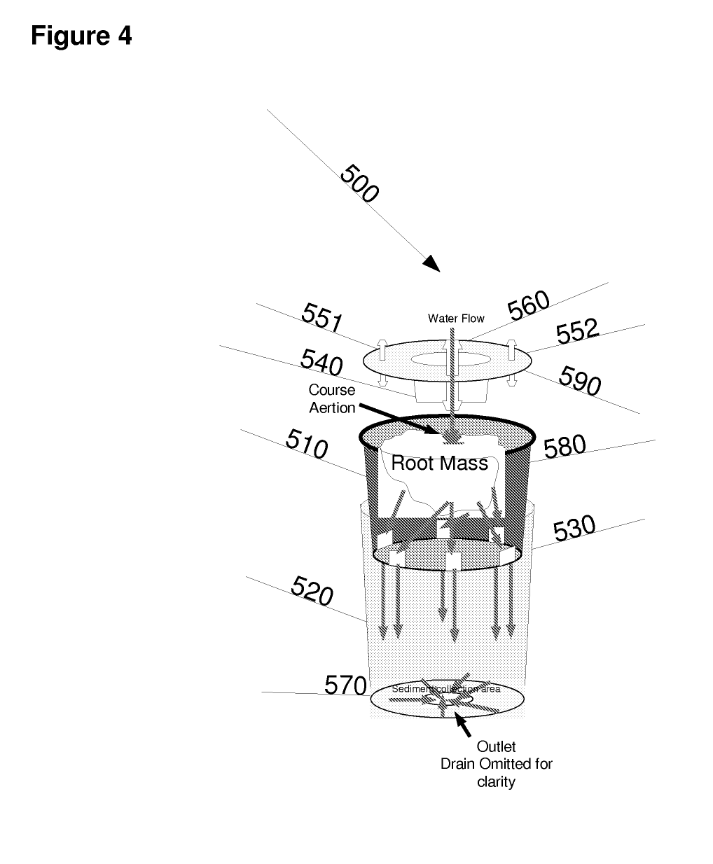

Turing to FIG. 4, shown is water-flow in an improved hydroponic grow bucket and top bucket assembly embodiment 500 of an improved hydroponic nutrient delivery gardening system. Included are a light-tight inner bucket 510, water-tight outer bucket 520, holes to allow water and air transfer from the inner bucket to the outer bucket 530, netpot 540, air inlet connectors 551 552, water inlet connector 560, drain 570, root mass 580, and top bucket assembly 590.

Water may be expelled through the water inlet connector 560 into the top of the bucket. This water movement may cause the water to bubble and mix, inducing course aeration.

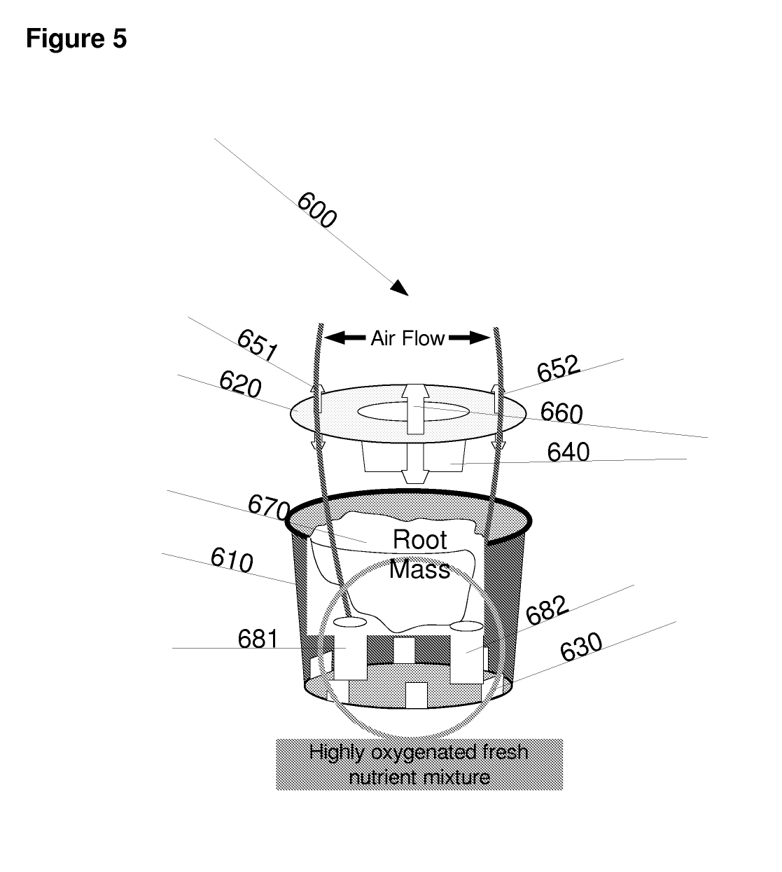

Turning to FIG. 5, shown is air-flow in an improved hydroponic light-tight inner bucket and top bucket assembly embodiment 600 of an improved hydroponic nutrient delivery gardening system. Included are a light-tight inner bucket 610, top bucket assembly 620, holes to allow water and air transfer from the inner bucket to the outer bucket 630, netpot 640, air inlet connectors 651 652, water inlet connector 660, root mass 670, and airstones 681 682.

Fine aeration may be achieved through the use of airstones 681 682 located inside the light-tight inner bucket 610. The airstones may be connected to the underside of the air inlet connectors 651 652. The topside of the air inlet connectors 651 652 may be connected to an air pump. This may create a continuous, high oxygenated nutrient mixture for the roots 670.

Although most DWC systems experience a predictable shift in pH throughout the feeding period. This shift is usually pH up immediately after feeding, then drops to below ideal over the week prior to the next week's change. With this system, pushing the air and water flow rates recommended, exhibits a very different behavior. The nutrient mixture is balanced prior to adding it to the reservoir, to minimize the pH shock to the plants when nutrients are introduced. Also, the nutrients are normally visible for a few days in the water before it begins to clear, depending on the nutrients used. With this system, the water is visibly clearer the morning following feeding, and the pH balances within 3 days to 5.8-6.0. This pH is maintained for the rest of the week, if nothing else is added. Because the nutrients appear to be absorbed so quickly by the plant, it is possible to feed at 100% on day 1, then feed again at 50% on day 4. Water is changed out weekly, and the reservoir is washed out monthly.

The air gap in the water system was ensures the trap functioned and would not create a vacuum to pull all the water out of the buckets. It also functioned as a “cooling tower” this past summer. In one example, tomatoes grew outdoors through May-August in Arizona without the use of a water chiller to maintain temperature. The reservoir was in the shade, but was outside with an ambient temperature above 90° F. for the entire period. Also, it was not necessary to seal the reservoir. Normally, there is a large emphasis placed on cleanliness and the prevention of any contaminant in the water. There were no issues using an open, 22 gallon reservoir on a 15 gallon (3×5 gallon) grow system outside a residential home.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

I claim:

1. An hydroponic apparatus comprising:
(a) an upper bucket assembly comprising:
(i) a netpot capable of holding a plant and having a plurality of netpot holes capable of allowing passage of plant roots therethrough; and
(ii) a platter installed above the netpot comprising:
(A) a platter opening that allows placement of the plant within the netpot;
(B) a water inlet for the passage of water through the platter; and
(C) an airflow inlet for the passage of airflow through the platter;
(b) a lower bucket assembly comprising:
(i) an outer bucket having an outer bucket top opening and an outer bucket bottom;
(ii) an outer bucket drain within the outer bucket bottom;
(iii) an inner bucket having an inner bucket top opening and an inner bucket bottom; and
(iv) at least one inner bucket hole within the inner bucket bottom;
wherein the inner bucket is securely installed within the outer bucket through the outer bucket top opening; and
wherein the top bucket assembly is securely installed within the inner bucket through the inner bucket top opening.

2. The apparatus as in claim 1, wherein the inner bucket is substantially opaque.

3. The apparatus as in claim 2, wherein the outer bucket except for the outer bucket drain and the outer bucket top opening is substantially watertight.

4. The apparatus as in claim 3, wherein water is capable of passing through the platter to the inner bucket via the water inlet and through the inner bucket to the outer bucket via at least one inner bucket hole.

5. The apparatus as in claim 4, further comprising plant nutrients and at least one airstone within the inner bucket and wherein airflow is capable of passing through the platter to the at least one airstone via the airflow inlet.

6. The apparatus as in claim 5, further comprising an air pump for driving the airflow through the platter to the at least one airstone via the airflow inlet.

7. A hydroponic system comprising:
(I) a reservoir for holding water;
(II) at least one bucket system apparatus, wherein each of the at least one bucket system apparatuses comprises:
(a) an upper bucket assembly comprising:
(i) a netpot capable of holding a plant and having a plurality of netpot holes capable of allowing passage of plant roots therethrough; and
(ii) a platter installed above the netpot comprising:
(A) a platter opening that allows placement of the plant within the netpot;
(B) a water inlet for the passage of water through the platter; and
(C) an airflow inlet for the passage of airflow through the platter;
(b) a lower bucket assembly comprising:
(i) an outer bucket having an outer bucket top opening and an outer bucket bottom;
(ii) an outer bucket drain within the outer bucket bottom;
(iii) an inner bucket having an inner bucket top opening and an inner bucket bottom; and
(iv) at least one inner bucket hole within the inner bucket bottom;
wherein the inner bucket is securely installed within the outer bucket through the outer bucket top opening;
wherein the top bucket assembly is securely installed within the inner bucket through the inner bucket top opening;
wherein water is capable of passing through the platter to the inner bucket via the water inlet and through the inner bucket to the outer bucket via at least one inner bucket hole; and
(III) a water manifold comprising a water manifold inlet connected to the reservoir and at least one water manifold outlet, wherein each of the at least one water manifold outlets is connected to a water inlet in a single bucket system apparatus;
(IV) a master drain; and
(V) a collection pipe connected to the outer bucket drain of each of the at least one bucket system apparatuses and to the master drain.

8. The system as in claim 7, wherein in each of the at least one bucket systems apparatuses, the inner bucket is substantially opaque.

9. The system as in claim 8, wherein in each of the at least one bucket systems apparatuses, the outer bucket except for the outer bucket drain and the outer bucket top opening is substantially watertight.

10. The system as in claim 9, further comprising in each of the at least one bucket systems apparatuses, plant nutrients and at least one airstone within the inner bucket and wherein airflow is capable of passing through the platter to the at least one airstone via the airflow inlet.

11. The system as in claim 10, further comprising:
(VI) a trap connected to the collection pipe to set the overall height of the water in each of the at least one bucket systems apparatuses.

12. The system as in claim 11, further comprising:
(VII) an adjustable sleeve interfacing with the trap for adjusting the overall height of the water in each of the at least one bucket systems apparatuses.

13. The system as in claim 12, wherein the adjustable sleeve is positioned to allow a large vertical drop of water into the reservoir.

14. The system as in claim 12, further comprising:
(VIII) a water chiller.

15. A hydroponic method comprising:
(I) growing a plurality of plants in a bucket system, wherein the bucket system comprises a plurality of bucket apparatuses, each bucket apparatus comprising:
(a) an upper bucket assembly comprising:
(i) a netpot capable of holding the plant and having a plurality of netpot holes capable of allowing passage of plant roots therethrough; and
(ii) a platter installed above the netpot comprising:
(A) a platter opening that allows placement of the plant within the netpot;
(B) a water inlet for the passage of water through the platter; and
(C) an airflow inlet for the passage of airflow through the platter;
(b) a lower bucket assembly comprising:
(i) an substantially watertight outer bucket having an outer bucket top opening and an outer bucket bottom;
(ii) an substantially opaque outer bucket drain within the outer bucket bottom;
(iii) an inner bucket having an airstone, an inner bucket top opening and an inner bucket bottom; and
(iv) at least one inner bucket hole within the inner bucket bottom;
wherein the inner bucket is securely installed within the outer bucket through the outer bucket top opening; and
wherein the top bucket assembly is securely installed within the inner bucket through the inner bucket top opening.
(II) in each bucket apparatus, inducing course aeration through the movement of water through the platter to the inner bucket via the water inlet to the plant roots and through the inner bucket to the outer bucket via at least one inner bucket hole;
(III) in each bucket apparatus, inducing fine aeration through the movement of air through the platter to the inner bucket via the air inlet to the plant roots and to the airstone.

16. The method as in claim 15, further comprising:
(IV) in each bucket apparatus, adding nutrients in the inner bucket so that the course aeration and fine aeration induce an oxygenated fresh nutrient mix for the plant roots.

17. The method as in claim 15 further comprising:
(IV) maintaining pH consistency of the water in each bucket apparatus by using a common source of water with a similar pressure in each bucket apparatus.

18. The method as in claim 17, further comprising:
(V) chilling the water.\

19. The method of claim 17, further comprising:
flushing the bucket system to substantially remove waste products from each inner liner bucket and outer bucket.

20. The method of claim 19, wherein the step of flushing is imitated by opening a drain at the lowest water point of the bucket system.
